(19) United States
(12) Patent Application Publication
(10) Pub. No.: US 2013/0179191 A1
(43) Pub. Date: Jul. 11, 2013

(54) METHOD AND SYSTEM FOR MANAGING PERSONAL HEALTH DATA

(71) Applicants: Francis E. Bal, Jackson, NJ (US); Michael D. Reilley, Nutley, NJ (US)

(72) Inventors: Francis E. Bal, Jackson, NJ (US); Michael D. Reilley, Nutley, NJ (US)

(21) Appl. No.: 13/719,744

(22) Filed: Dec. 19, 2012

Related U.S. Application Data
(60) Provisional application No. 61/579,232, filed on Dec. 22, 2011.

(51) Int. Cl. G06F 19/00

(52) U.S. Cl. CPC G06F 19/322
USPC 705/3

(57) ABSTRACT

The present invention is a method and system for using a mobile or desktop computing device, such as a cellular telephone or personal computer, to store an individual's health parameters. These health parameters may include blood work, urine tests, etc. and also standard personal factors such as weight, diet habits, medications, allergies, etc. The health parameters can be plotted on color coded graphs. The color-coded parameters will manifest themselves in the form of “trend lines”, which will identify the ‘direction’ the particular health parameters are moving. The invention will allow the health data to be plotted individually or correlated with other parameters to predict an individual's “state of health” (SOH). This correlated trending data provides an individual with a means to determine if some type of proactive health measure could be taken to stop a negative trend and prevent more drastic actions, such as medication or surgery.

### CROSS-REFERENCE TO RELATED APPLICATIONS

This application claims the benefit of U.S. provisional application No. 61/579,232, filed Dec. 22, 2011, which is incorporated by reference as if fully set forth.

### STATEMENT REGARDING FEDERALLY SPONSORED RESEARCH AND DEVELOPMENT

(Not Applicable.)

### FIELD OF THE INVENTION

This invention relates to methods and systems for managing personal health data, and in particular to a method and system for storing, trending and correlating an individual's critical health parameters on a mobile or desktop computing device.

### DISCUSSION OF RELATED ART

Portable medical alert devices are available which can be configured to send out medical alerts or alarms to healthcare providers or medical emergency personnel when a patient is in need of medical attention. Such devices might be worn around the patient's neck or wrist. A serious limitation of these devices is their inability to provide any information in regards to the medical history of the patient. Another limitation of such devices is their inability to identify the trends of the patient's specific health parameters, and their inability to correlate the various health parameter data.

An individual might require medical attention at any time. If a patient is disabled or unconscious, medical personnel may have difficulty in obtaining the necessary medical information. Even if a patient is conscious, medical personnel may have to rely on the patient's narratives to obtain medical information in an emergency. If a patient's medical information and medical trending information is readily available, medical personnel can administer the patient's medical treatment much more effectively.

The present invention is a method and system for using a mobile or desktop computing device, such as a cellular telephone or personal computer, to store an individual's health parameters. These health parameters may include blood work, urine tests, etc. and standard personal factors such as weight, diet habits, medications, allergies, etc. The invention includes a health data software application that plots health parameters on color coded graphs. Color-coded parameters will manifest themselves in the form of “trend lines”, which will identify the ‘direction’ the particular health parameters are moving (positive, negative or trending positive or negative). The invention will allow the health data to be plotted individually or correlated with other parameters to predict an individual's “state of health” (SOH). The substantial benefit of this trending correlation is to empower the individual to work proactively with their physician to maintain good health while alerting the individual to a negative health trend before it becomes necessary to utilize more drastic measures such as medications or surgery.

Clearly, there is a need for a system for assessing an individual's health data in an efficient manner. Such a system would identify the device user's health trends and correlate the device user's health data. The present invention accomplishes these objectives.

### SUMMARY OF THE INVENTION

The present invention is a method and system for managing personal health data, including implementing a Health Data Application on a mobile or desktop computing device such as a cellular telephone or a personal computer. The Health Data Application executes various functions including storing an individual's health parameters, such as blood work, urine tests, etc. and standard personal factors such as weight, diet habits, medications, allergies, etc., and plotting the health parameters on color coded graphs.

The Health Data Application operates on any of a variety of mobile or desktop computing devices. The mobile or desktop computing device includes a processor, memory, a database, storage media, an optional Internet interface, keyboard, and screen. The mobile computing or desktop device memory houses software applications such as the Health Data Application and the application database. The application database stores the user's health data and personal information including blood work, height, weight, blood pressure (BP), etc. The mobile computing or desktop device displays the Health Data Application's icons, data and trending charts on its user display.

Some embodiments of the invention may include an Internet interface that allows the mobile computing or desktop device to communicate with various interfaces including a Laboratory Database Interface that provides testing results to the mobile or desktop computing device, a Physician's Database Interface that transfers health data to a physician, and a Hospital Database Interface that transfers health data to a hospital.

The Health Data Application executes a number of key functions including displaying color coded graphs of Current Procedural Terminology (CPT) code results and personal health data, and applying Trending Algorithms to personal health data. These Trending graphs may also be grouped to provide correlations between the various CPT code results and other personal health data.

Trending Algorithms are performed on two sequential test results either from a lab test or from data entered manually. Trend lines represent present and historical Current Procedural Terminology (CPT) Codes and personal health data in color coded graphical formats. The trend line color codes indicate any of the following three trends: a) green indicates positive data or trending positive from the last test, or b) yellow indicates trending negative from positive from the last test, or c) red indicates negative test data. The Health Data Application determines the trend line color coding by utilizing the Trending Algorithms.

The Pre-defined Trending Correlations comprise a group of trending charts on one display with the same time base which allows for the correlation of each of the charts to one another for comparison purposes. This allows the user to determine correlations between different health data variables.

A Current Procedural Terminology (CPT) code represents a blood or urine analyte or component such as glucose, cholesterol, triglycerides, etc. The CPT code is provided by a lab report based on a prescribed blood or urine test.

The Trending Algorithm variables are defined as follows: a₁ and a₂ are either the CPT code for a particular test or the personal health factor (such as BP or weight manually entered). A₁ is the previously stored test result. A₂ is the new stored test result or manual test result performed after the a₁ test result. The upper and lower thresholds are provided by the testing lab and are generally held to be the levels that should not be crossed for a particular test. U_{T} is the upper CPT Code threshold set by the particular CPT code which was tested and sent with the CPT code included with the lab data. For personal health factors it will be either set by the Health Data Application 10 or entered by the user. If no upper threshold U_{T} is defined (such as when aₙ must be greater than 60 mg/dL (L_{T})), then the application sets

U_{T}=L_{T}+100 Units. L_{T} is the Lower Threshold for the CPT code or personal health factor. If no lower threshold is defined (such as when aₙ must be less than 60 mg/dL (U_{T})), then the application sets L_{T}=0.1(U_{T}). The variables a₁ and a₂ as well as the Upper and Lower thresholds are read from the application database where the Lab Reports and manually entered personal health data are stored.

The trend line color coding of the graphical representation of a CPT Code or manually entered personal health data is based upon the application of several algorithms described in the detailed description section.

### DESCRIPTION OF THE DRAWINGS

FIG. 1 is a diagram depicting the computing hardware and interfaces in accordance with an embodiment of the present invention;

FIG. 2 is a flowchart of a health data application activation in accordance with an embodiment of the present invention;

FIG. 3 is a flowchart of the main menu items in accordance with an embodiment of the present invention;

FIG. 4 is a flowchart of a personal data menu in accordance with an embodiment of the present invention;

FIG. 5 is a flowchart of a medical data menu in accordance with an embodiment of the present invention;

FIG. 6 is a flowchart of a my trends menu in accordance with an embodiment of the present invention;

FIG. 7 is a depiction of a Lab Data Screen in accordance with an embodiment of the present invention;

FIG. 8 is a depiction of a Get Lab Test Results Screen in accordance with an embodiment of the present invention;

FIG. 9 is a depiction of a List of Pre-Defined Correlations Screen in accordance with an embodiment of the present invention;

FIG. 10 is a depiction of a Add/Edit Trend Screen in accordance with an embodiment of the present invention;

FIG. 11 is a Health Overview Pre-Defined Trending Correlations Chart in accordance with an embodiment of the present invention.

### DETAILED DESCRIPTION OF THE PREFERRED EMBODIMENT

The present invention is a method and system for managing personal health data, including implementing a Health Data Application 10 on a mobile or desktop computing device, such as a cellular telephone or personal computer. The Health Data Application stores an individual's health parameters, such as blood work, urine tests, etc. and standard personal factors such as weight, diet habits, medications, allergies, etc., and plots the health parameters on color coded graphs.

The Health Data Application 10 executes a number of key functions including displaying color coded graphs of Current Procedural Terminology (CPT) code results, and applying Trending Algorithms to personal health data. These Trending graphs may also be grouped to provide correlations between the various CPT code results and other personal health data.

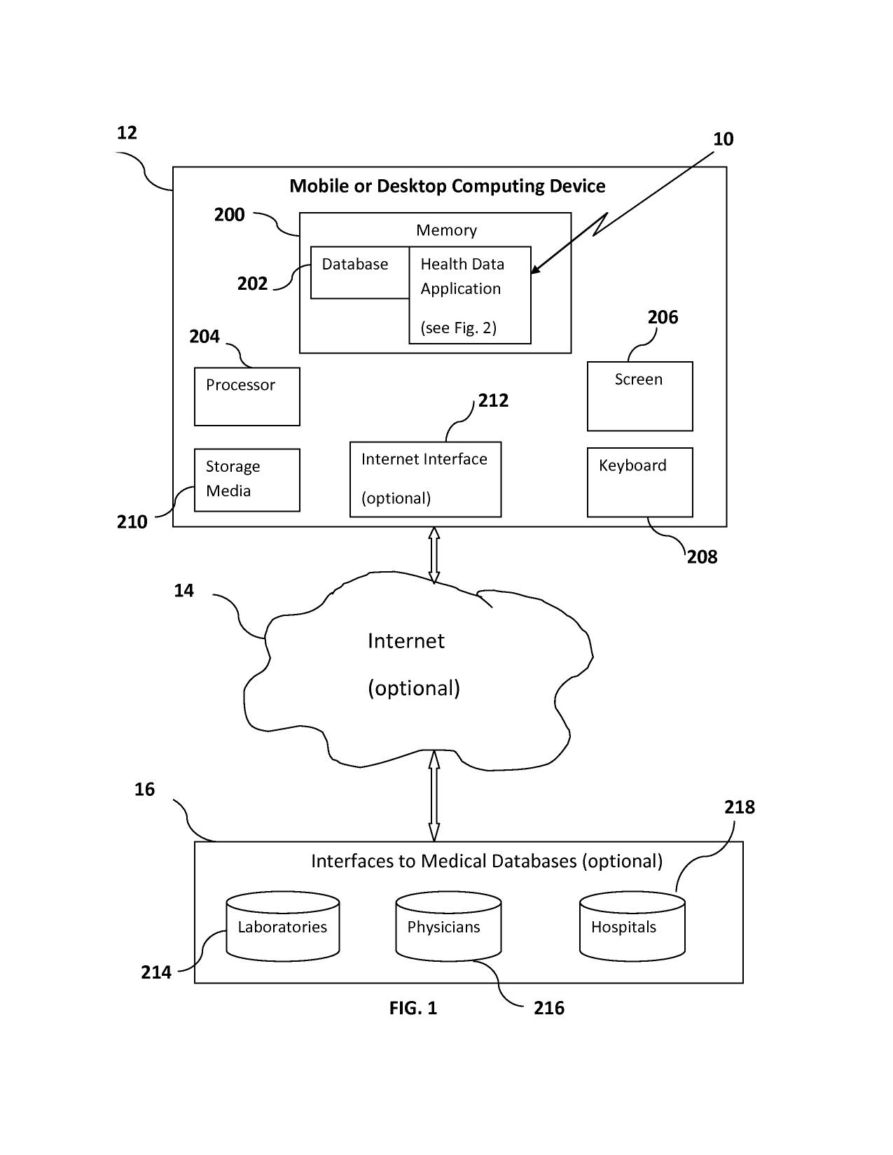

Exemplary embodiments of the present inventions are depicted in the various drawing figures. FIG. 1 is a diagram depicting the system hardware and software in accordance with an embodiment of the present invention. A Health Data Application 10 operates on a mobile or desktop computing device 12 (such as an iPhone, iPad, Android phone, Blackberry, Personal Computer, etc.). The mobile or desktop computing device 12 includes a processor 204, memory 200, an application database 202, storage media 210, an optional Internet interface 212, keyboard 208, and screen 206. The mobile or desktop computing device memory 200 houses software applications such as the Health Data Application 10 and the application database 202. The application database 202 contains the user health information such as blood work and personal health data including height, weight, blood pressure, etc. The mobile or desktop computing device screen 206 displays the Health Data Application's 10 icons, data and trending charts. The mobile or desktop computing device keyboard 208 is used to input data and commands to the Health Data Application 10. In some embodiments of the invention 12 the keyboard 208 may be a separate hardware device, and in other embodiments it may be incorporated into the screen 206 for touch typing. The mobile or desktop computing device storage device 210 may be either memory based or may be comprised of external hardware which allows data to be stored by the application.

The mobile or desktop computing device 12 may consist of any of a variety of electronic devices including mobile telephones, cellular telephones, PDA's equipped with communication capabilities, and mobile computers or palm computers and desktop personal computers with various wireless communication capabilities. The desktop computing device may be comprised of any of the standard devices available which support both the Apple or Microsoft operating systems with interfaces to the Internet. In addition to supporting the functionality of the present invention, the mobile computing device may also provide common mobile communication functions such as placing telephone calls.

Some embodiments of the invention may include an Internet interface 212 which allows the mobile or desktop computing device 12 to communicate over the Internet 14 with various Medical Interfaces 16. Medical Interfaces 16 may include a Laboratory Database Interface 214 that provides testing results to the mobile or desktop computing device, a Physician's Database Interface 216 for transferring health data to a physician, and a Hospital Database Interface 218 for transferring health data to a hospital.

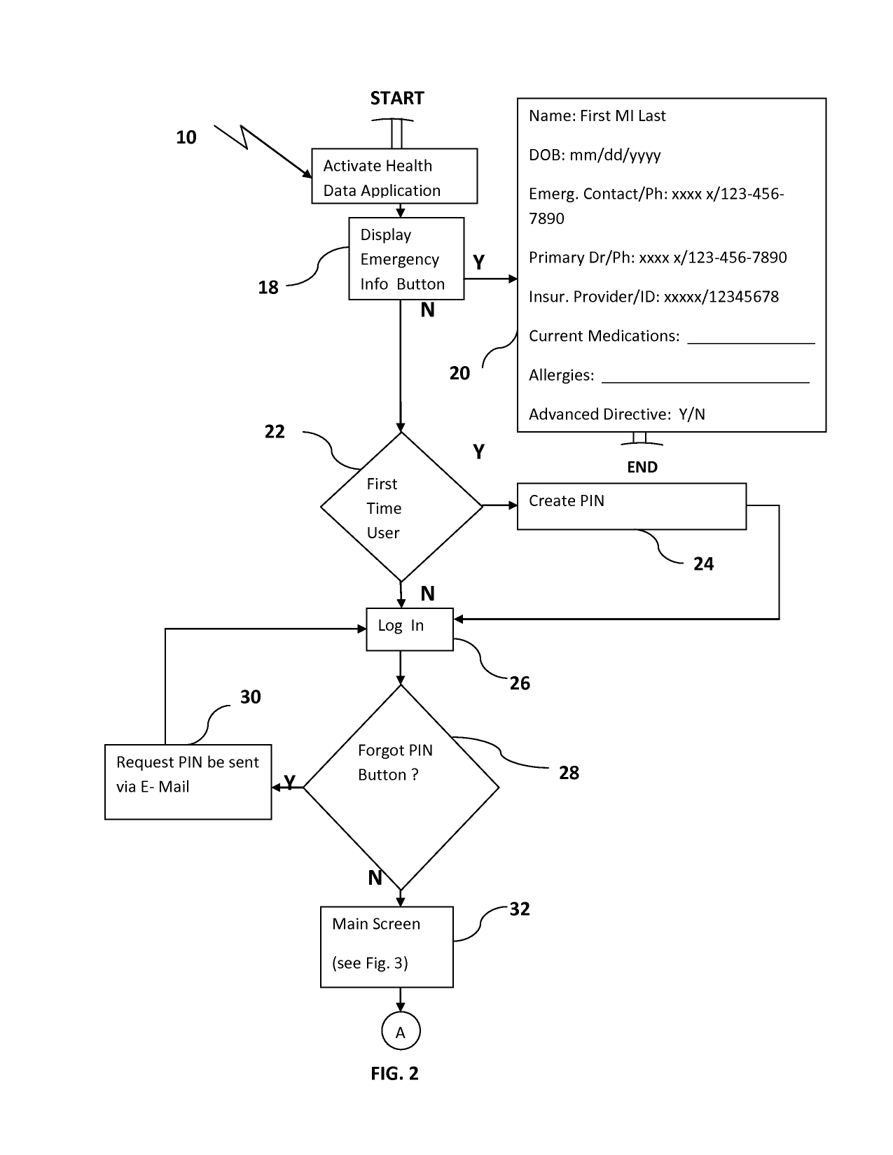

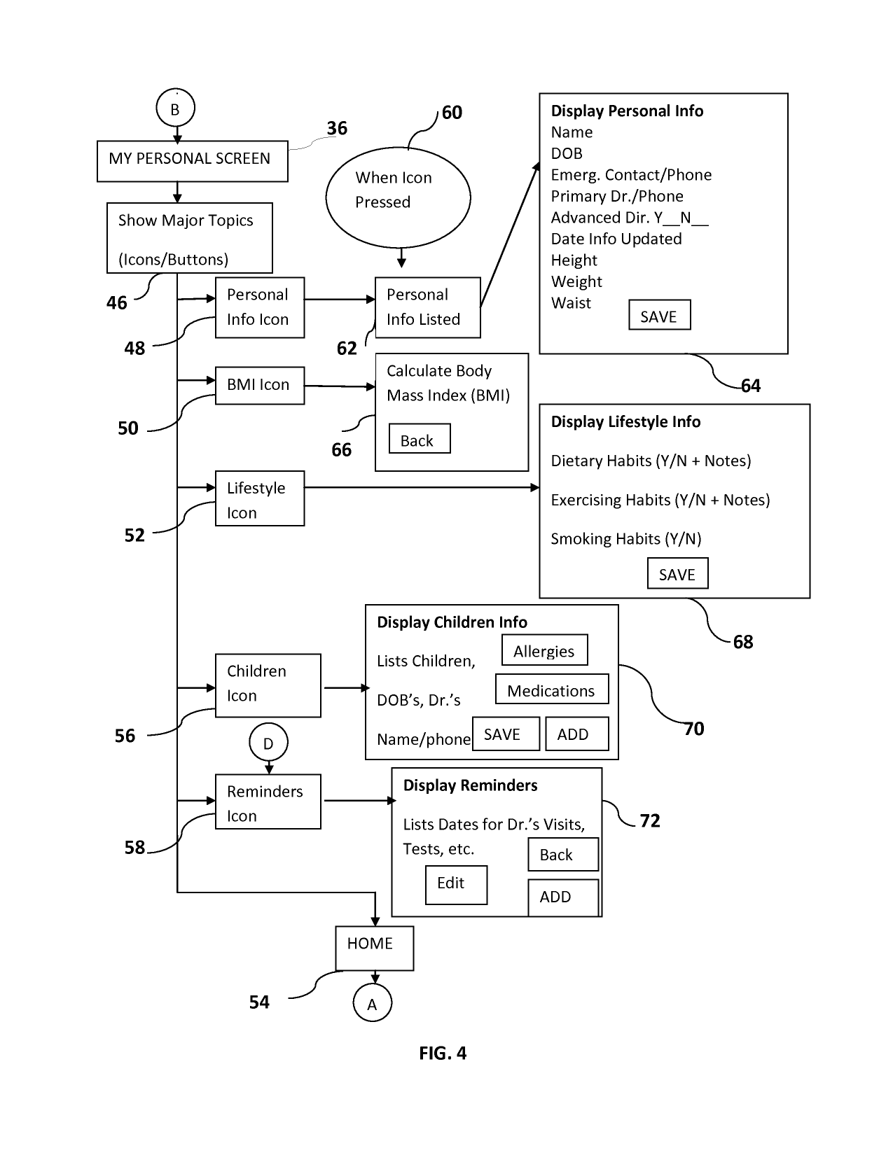

Referring now to FIG. 2, a flowchart of a Health Data Application 10 activation in accordance with an embodiment of the present invention is shown. When an emergency button is depressed (step 18), the emergency information screen (step 20) appears on the screen 206 of the mobile or desktop computing device 12. The user's vital data is displayed including name, date of birth, emergency contact numbers, primary doctor number, insurance provider, and current medications which are extracted from the data in the My Personal Screen (FIG. 4, step 36). If the emergency button has not been depressed, the user may depress the first time user button which then displays the create PIN screen (step 24). The user is prompted to create a PIN, and is then directed to the Log In screen (step 26). If the first time user button is not depressed, the application also displays the log in screen (step 26).

If the user does not have their log in information available, the user may depress the Forgot PIN button (step 28). The Health Data Application 10 will then allow the user to retrieve the PIN information via E-Mail (step 30), and the user is returned to the log in screen (step 26). If the user has not depressed the Forgot PIN button (step 28), the Health Data Application 10 displays the Main Screen (step 32, FIGS. 2 & 3).

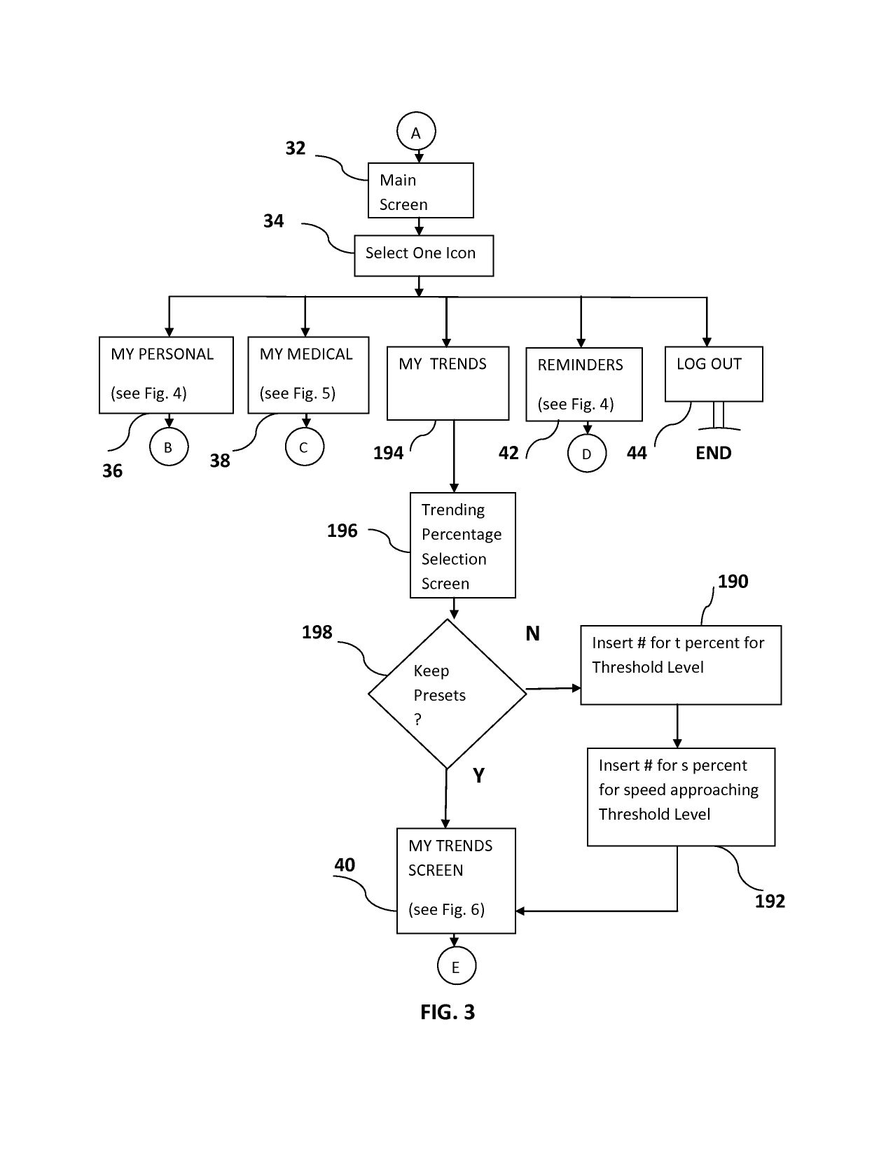

Referring now to FIG. 3, the user is prompted to select one of the Main Screen icons (step 34). The Main Screen choices include the My Personal screen (step 36), the My Medical screen (step 38), the My Trends screen (step 194), the Reminders screen (step 42), and Log Out (step 44), which closes the Health Data Application 10 and returns control to the mobile or desktop computing device. Upon selecting My Trends (step 194), the application displays the Trending Percentage Selection screen (step 196). The user is prompted whether to keep the Preset values (step 198). If the user selects no to keeping the Preset values (step 198), the user is then prompted to enter a number for the percentage of the t Threshold Level (step 190), and also the number for the percentage of the s Threshold Level (step 192). The variable t equals the percentage below the Upper Threshold Level for the analyte tested (U_{T}), or else t equals the percentage above the Lower Threshold level of the analyte tested (L_{T}), thereby indicating a zone approaching one of the thresholds (warning zone). T is initially set to 25% (0.25), but it can be varied by the user to provide a greater or lesser warning zone size. The variable s equals a percentage relating to the slope of a₁a₂ (where a₁ is the first data point of a tested analyte and a₂ is the second data point) which could trigger a warning based on the “speed” at which a subsequent test is approaching a warning zone. S is initially set to 20% (0.2), but it can also be varied by the user to increase or decrease the slope of the test result as it approaches a warning zone.

The application then displays the My Trends screen (step 40). If the user had selected yes to keeping the Preset values (step 198), the application will proceed to the My Trends screen (step 40, FIGS. 3 & 6).

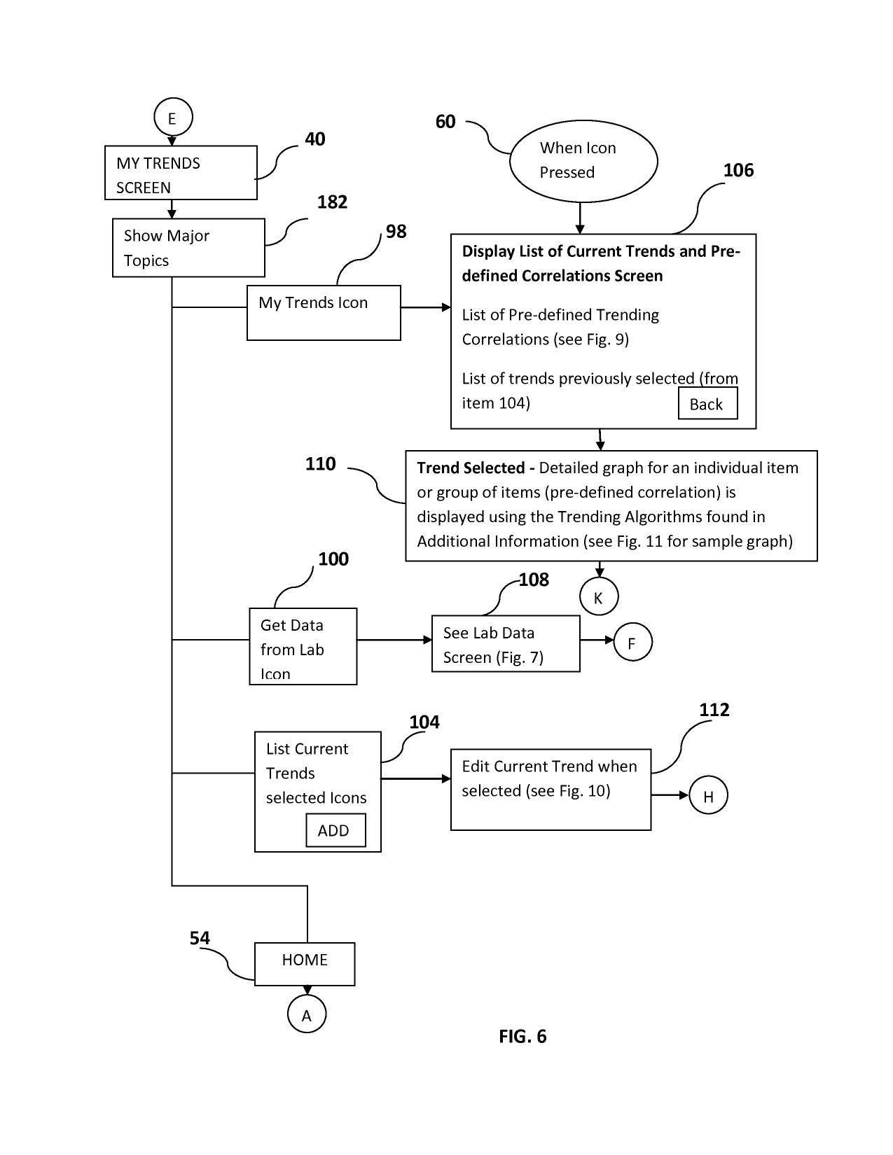

Turning now to FIG. 6, the user has arrived at the My Trends screen (step 40) from the Trending Percentage Selection screen (step 196, FIG. 3). The Health Data Application 10 displays the Show Major Topics icons (step 182). At the Show Major Topics menu (step 182), the Health Data Application 10 displays the My Trends icon (step 98), the Get Data from Lab icon (step 100), the List Current Selected Trends icon (step 104), and the Home icon (step 54).

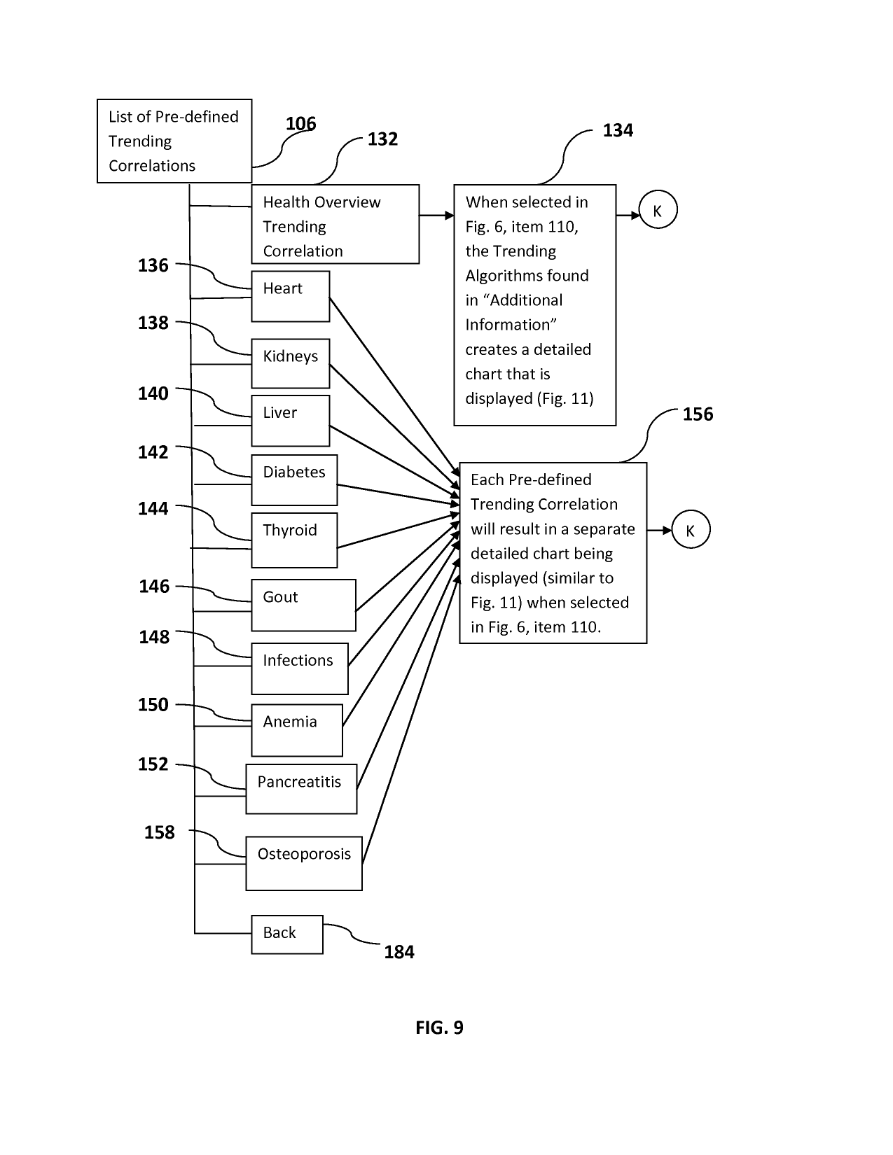

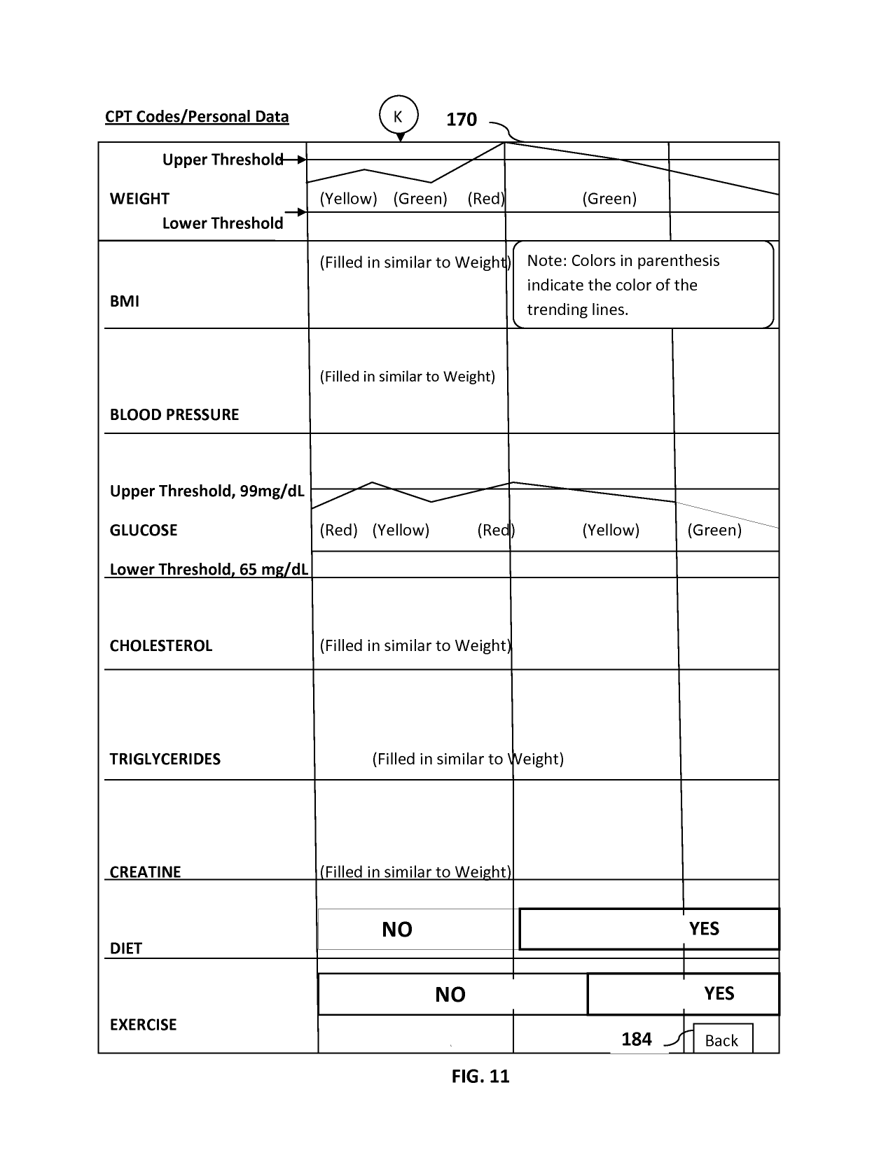

If the user selects the My Trends icon (step 98), the List of Current Trends screen is displayed (step 106), which includes a drop down list of pre-defined trending correlations, and a list of trends previously selected. When a specific Current Trend or Pre-defined Correlation (FIG. 9) is selected (step 110), the Trending Algorithms shown in “Additional Information” are used to create a graph or graphs which are then displayed similar to FIG. 11. If the user selects the Get Data from Lab icon (step 100), the Lab Data Screen (step 108) is displayed. If the user selects the List Current Trends Selected icon (step 104), additional individual trends may be added and any of the trends listed may be selected to display the Edit Current Trend Screen (step 112).

Referring now to FIG. 4, the user has selected the My Personal Screen (step 36) from the Main Screen (FIG. 3, step 32). Upon entering the My Personal Screen (step 36), the Health Data Application 10 displays the Show Major Topics icons (step 46). The Show Major Topics icons (step 46) displays the Personal Info icon (step 48), the Body Mass Index (BMI) icon (step 50), the Lifestyle icon (step 52), the Children icon (step 56), and the Reminders icon (step 58). The user may also return to the Main Screen (FIG. 3, step 32) via the Home icon (step 54).

At the Show Major Topics icons (step 46), if the user selects the Personal Info icon (step 48), a screen listing all personal information is displayed (step 62). When an icon is depressed (step 60), the Personal Information screen is displayed (step 64) on the screen or on a separate screen. The Personal Information screen (step 64) includes such data as the user's Name, Date of Birth, Contact information, etc., in addition to personal measurement information such as height, weight, waist size, etc. along with the option to overwrite the information, or else return to the previous screen.

If the user selects the BMI icon (step 50), the Calculate BMI screen is displayed (step 66). The BMI is calculated using a standard formula based on the current data from the user's personal information. BMI is computed as follows: BMI=((mass in lbs)/((height in inches) squared)))×703. The user may then select the Back icon which will bring them back to the My Personal Screen, (step 36). If the user selects the Lifestyle icon (step 52), current Diet, Exercise, and Smoking Habits are displayed with the option to Overwrite them or go back to the previous screen. If the user selects the Children icon (step 56), a screen displays the user's children's names, DOB's, physicians, allergies, and medications with the option to overwrite this information or return to the previous screen (step 36). If the user selects the Reminders icon (step 58), a list of dates of Physicians' visits, lab tests, etc. is displayed with the ability to overwrite this information or go back to the previous screen (step 36).

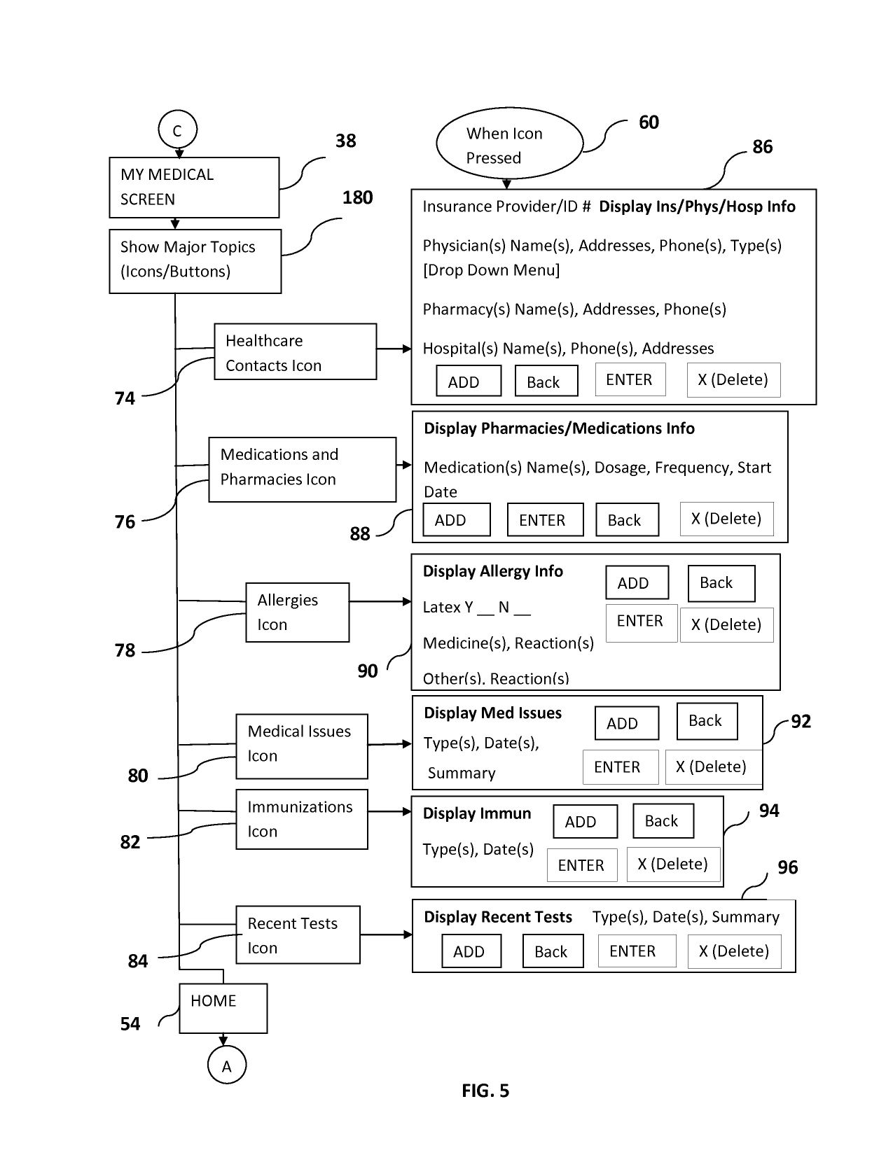

Referring now to FIG. 5, the user has selected the My Medical Screen (FIG. 3, step 38) from the Main screen (FIG. 3, step 32). Upon entering the My Medical Screen (step 38), the Health Data Application 10 proceeds with the Show Major Topics icons (step 180). The Show Major Topics icon (step 180) displays the Healthcare Contacts icon (step 74), the Medications and Pharmacies icon (step 76), the Allergies icon (step 78), the Medical Issues icon (step 80), the Immunizations icon (step 82), the Recent Tests icon (step 84) and the Home icon (step 54) which returns the user to the Main Screen, (FIG. 3, step 32).

If the user selects the Healthcare Contacts icon (step 74), the Health Data Application 10 displays the user's insurance and ID number as well as the user's physician and hospital information including names, phone numbers, addresses, specialties, etc, as well as pharmacy information including names, addresses, phone numbers, etc. (step 86). The user may then either overwrite the data or else return to the previous screen. If the user selects the Medications and Pharmacies icon (step 76), Medication information such as names, dosages, frequencies, start dates, etc. as well as the ability to add new medication items are displayed (step 88). The user may then either overwrite the data or else return to the previous screen. If the user selects the Allergies icon (step 78), the Health Data Application 10 displays data about Latex allergies, along with data about medicines causing reactions and data about other allergies with reactions (step 90). The user may then either overwrite the data or return to the previous screen. If the user selects the Medical Issues icon (step 80), the Health Data Application 10 displays medical issue types, dates and summaries (step 92). The user may then either overwrite the data or else return to the previous screen. If the user selects the Immunizations icon (step 82), the Health Data Application 10 displays immunization types and dates (step 94). The user may then either overwrite the data or else return to the previous screen. If the user selects the Recent Tests icon (step 84), the Health Data Application 10 displays types of tests, dates and summaries (step 96). The user may then either overwrite the data or else return to the previous screen.

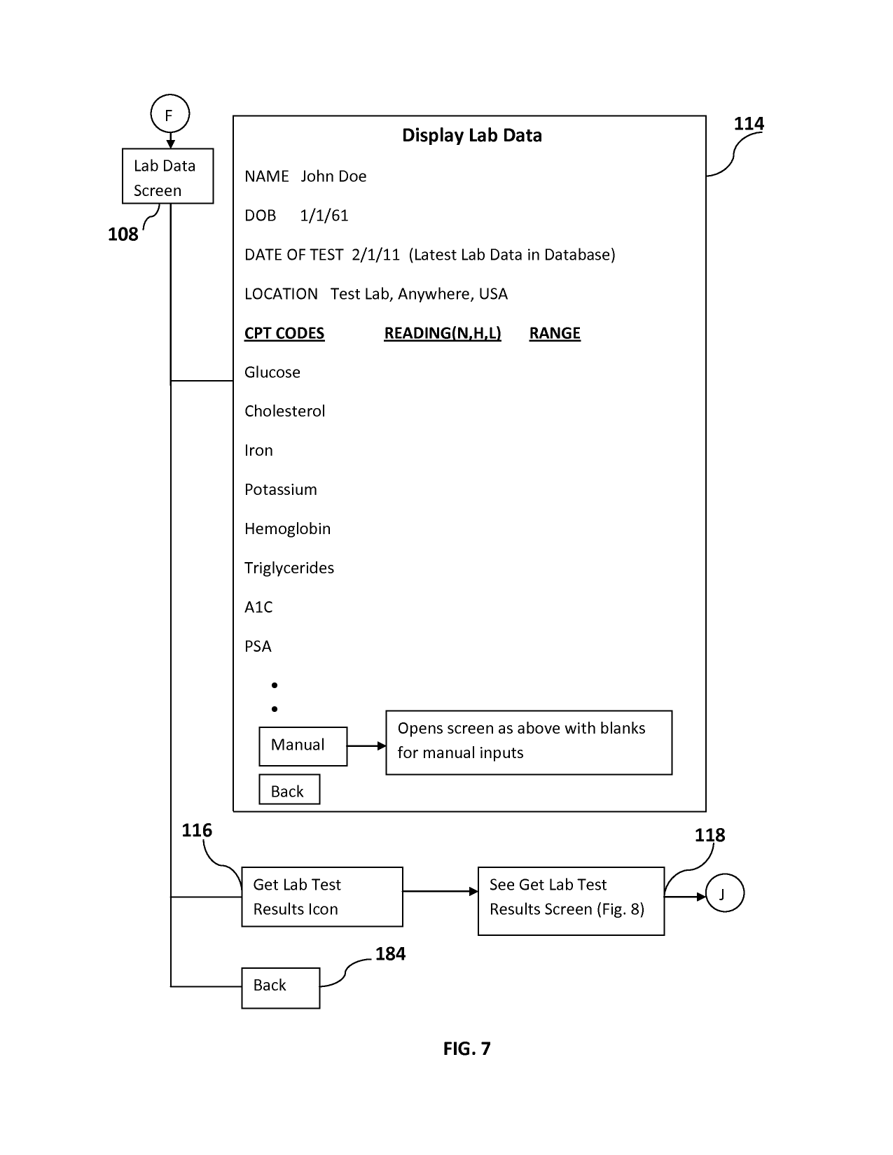

Referring now to FIG. 7, the user has selected the Lab Data icon (FIG. 6, step 108), and has arrived at the Lab Data icon (step 108). The user may select the Lab Data icon (step 108), Get Lab Test Results icon (step 116), or else the Back icon (step 184). When the Lab Data icon (step 108) is pressed, the Lab Data Screen is displayed, (step 114) which contains the the name of the patient, DOB, date of the test and location. The Display Lab Data Screen (step 114) also displays the Current Procedural Terminology (CPT) Codes, the actual test data with flags (normal, high, low), and the normal range. If the user selects the Get Lab Test Results icon (step 116), the Get Lab Test Results screen (step 118) is displayed.

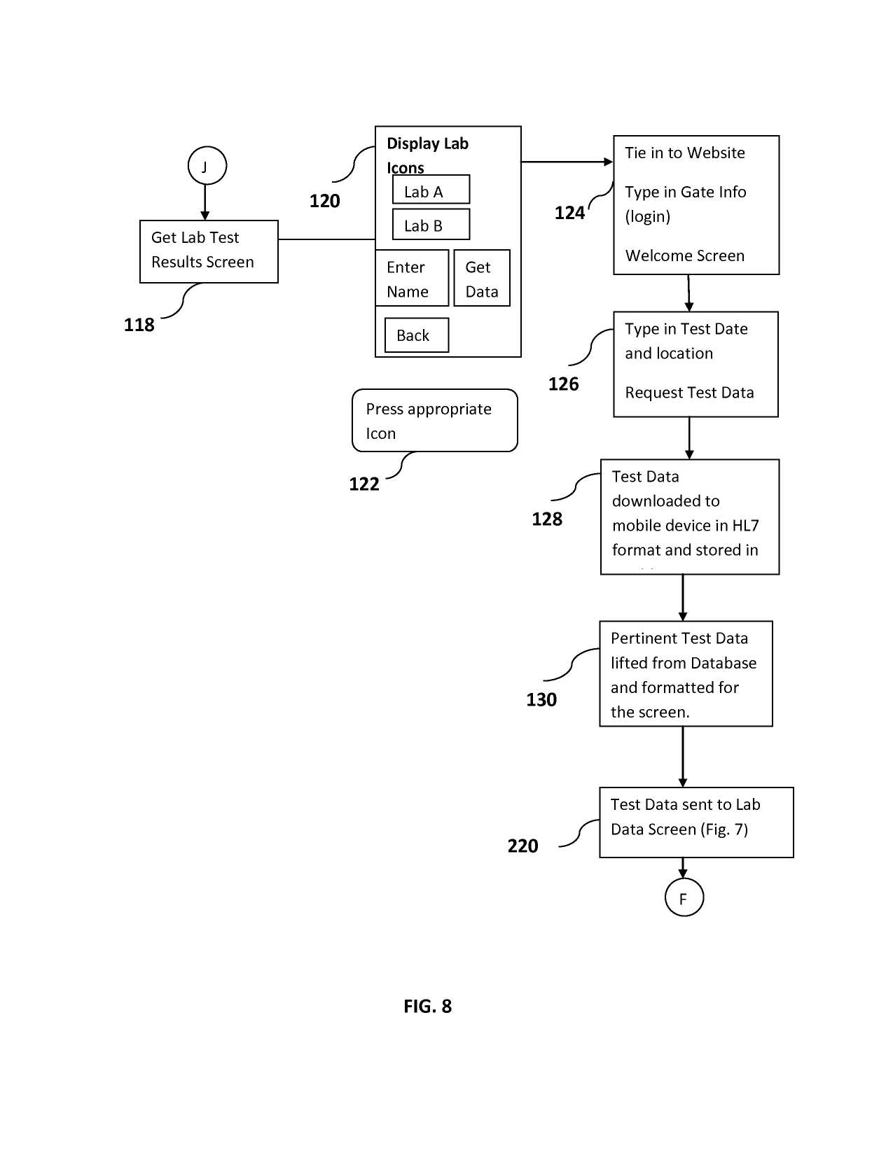

Referring to FIG. 8, the user has selected the Get Lab Test Results icon (step 116 in FIG. 7), and the Get Lab Test Results (step 118) screen is then displayed. The Display Lab Icons screen (step 120) displays icons for current labs such as Lab A and Lab B, with an option to enter any Lab name. The appropriate sequence of icons must be depressed, i.e. one of the current labs or a new Lab name (step 122). Once a lab has been chosen, the Get Data icon (step 120) may be depressed which permits interfacing with the laboratory database interface 214 via the Internet 14 (FIG. 1) by way of step 124. Another option is to go back to the previous screen. When the Get Data icon (step 120) is depressed, the lab website 214 (FIG. 1) is accessed via the Internet, login data is entered, and a Welcome Screen is displayed by the website (step 124). In step 126, the test date and location are entered and the test data is requested. Electronic Health Record data is then downloaded in HL7 format to the mobile or desktop computing device 12 and stored in the mobile or desktop computing device application database 202 (FIG. 1) in step 128. In step 130 pertinent test data is read from the mobile or desktop computing device application database 202 and formatted to fit the Lab Data Screen 114 (FIG. 7). The formatted test data is then sent to the Lab Data Screen 114 (step 220).

Referring to FIG. 9, a List of Pre-Defined Trending Correlations (step 106) is presented in a drop down format in step 106 in FIG. 6. The Pre-Defined Trending Correlations drop down list (FIG. 9, step 106) in some embodiments of the invention includes the following icons: Heart (step 136), Kidneys (step 138), Liver (step 140), Diabetes (step 142), Thyroid (step 144), Gout (step 146), Infections (step 148), Anemia (step 150), Pancreatitis (step 152), Osteoporosis (step 158) and Back (step 184). Other embodiments of the invention may utilize other Pre-Defined Trending Correlations lists. When any of the Pre-defined Trending Correlation icons are selected (step 106), a separate detailed chart similar to FIG. 11 will be displayed with the appropriate CPT Codes and personal health data trended using the trending algorithms described below.

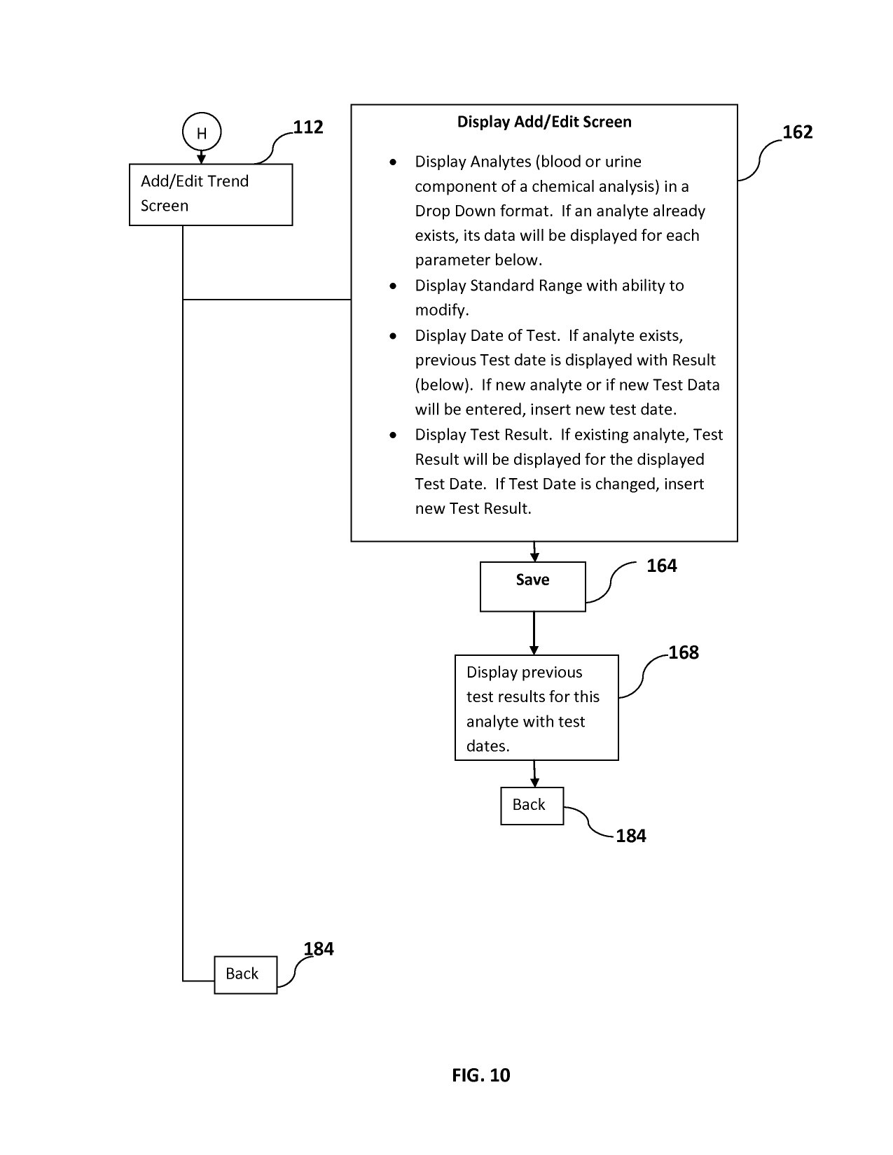

Referring to FIG. 10, the Add/Edit Trend Screen (step 112) is displayed after the user selects the List Current Trends icon (step 104) in FIG. 6. The Add/Edit Trend screen (step 112) displays the Add/Edit display screen (step 162). The Add/Edit display screen (step 162) displays analytes (blood or urine component of a chemical analysis) in a drop down format. If the analyte already exists in the application database 202, all of its parameters are displayed. The Standard Range for the analyte will be displayed with the ability to modify it. The Date of the Test will display if the analyte already exists along with the Test Result. If this is a new analyte or a new Test Date is entered for an existing analyte, the Test Result will be blank awaiting the entering of the new Test Result. When the test information is complete, the Save icon (step 164) may be pressed to store this test data in the application database 202. After the Save icon (step 164) is pressed and the data is stored, the previous test results (if available) for this analyte are then displayed on the screen (step 168).

Table 1 shows the analytes displayed by the Health Data Application that have a range. The ranges are derived from standard blood and urine tests.

The Health Overview Trending Correlation Chart (FIG. 11, step 170) lists the appropriate CPT Codes and personal health data and provides the color coded graphing of each CPT code versus time utilizing the Trending Algorithms. This allows the CPT Codes and personal health data to be correlated to each other.

A Current Procedural Terminology (CPT) code represents a blood or urine analyte or component such as glucose, cholesterol, triglycerides, etc. The CPT code is provided by a lab report based on a prescribed blood or urine test.

In some embodiments of the invention, many health data variables may be entered manually into the Health Data Application 10. In some cases, the user may be prompted to enter health data upon first entering the Health Data Application 10. Alternatively, the first iteration of many of the Health Data Application 10 screens may have a header followed by blank fields to be filled in by the user. In the various flowchart steps, including steps 70, 72, 86, 88, 90, 92, 94, 96, 104 in FIGS. 4,5, and 6, Add refers to the manual updating of health information. In the various flow chart steps, including steps 64, 68 and 70 in FIG. 4, Save is used to save the information manually entered and go back one screen in the Health Data Application 10. In the various flow chart steps, including 86, 88, 90, 92, 94 and 96 in FIG. 5, Enter refers to saving new data that has been manually entered. In various flow chart steps, including 86, 88, 90, 92, 94 and 96 in FIG. 5, X (delete) refers to deleting information that had been previously saved in a screen. Flowchart step 114 (FIG. 7) allows the user to manually input health data variables (CPT codes with their respective data, flags, and ranges) into a blank screen. In the various flowchart steps, including steps 184, 72, 86, 88, 90, 92, 94, 96, 106, 114, and 120 in FIGS. 4,5, 6, and 8, Back (B) refers to going back one screen in the Health Data Application 10. In the various flow charts, step 54 refers to going back to the Home page in FIGS. 4, 5, and 6, Home refers going back to FIG. 3, step 32.

Trending Algorithms are performed on two sequential test results either from a lab test or from data entered manually. Trend lines represent present and historical Current Procedural Terminology (CPT) Codes and personal health data in color coded graphical formats. The trend line color codes indicate any of the following three trends: a) green indicates positive data or trending positive from the last test, or b) yellow indicates trending negative from positive from the last test, or c) red indicates negative test data. The application determines the trend line color coding by utilizing the Trending Algorithms. In the various flowchart steps, including steps 110, 134, 156 and 170 in FIGS. 6, 9, and 11, the Trend (T) selection provides present and historical Current Procedural Terminology (CPT) Codes and personal health data in color coded graphical format as specified above.

The Pre-defined Trending Correlations comprise a group of trending charts on one display with the same time base which allows for the correlation of each of the charts to one another for comparison purposes. This allows the user to determine correlations between different health data variables. Flowchart items 106, 110, 132, 134, 136, 138, 140, 142, 144, 146, 148, 150, 152, 156, 158, and 170 contain the option to display the Pre-defined Trending Correlations.

The Trending Algorithm Variables are Defined as Follows:

a₁ and a₂ are either the CPT code for a particular test or the personal health factor (such as BP or weight manually entered). A₁ is the previously stored test result. A₂ is the new stored test result or manual test result performed after the a₁ test result.

The upper and lower thresholds are provided by the testing lab and are generally held to be the levels that should not be crossed for a particular test. U_{T} is the upper CPT Code threshold set by the particular CPT code which was tested and sent with the CPT code included with the lab data. For personal health factors it will be either set by the Health Data Application 10 or entered by the user. If no upper threshold U_{T} is defined (such as when aₙ must be greater than 60 mg/dL (L_{T})), then the application sets

U_{T}=L_{T}+100 Units.

L_{T} is the Lower Threshold for the CPT code or personal health factor. If no lower threshold is defined (such as when aₙ must be less than 60 mg/dL (UT)), then the application sets

L_{T}=0.1(U_{T}).

The variables a₁ and a₂ as well as the Upper and Lower thresholds are read from the application database 202 where the Lab Reports and manually entered personal health data are stored. The t and s percentage variables are also in the data base and may be modified by the user (items 190 and 192 in Flow Chart FIG. 3). The operations on variables, ie the Trending Algorithms, are specified in each step where they can occur in FIG. 6, step 110, which allows the user to select a pre-defined list of CPT codes and personal health data in Trending form on one display, similar to FIG. 11. The Trending Algorithms therefore utilize the variables.

The trend line color coding of the graphical representation of a CPT Code is based upon the application of the following algorithms which are applied in the following sequence:

1. If a₂<L_{T} or a₂>U_{T}, then the color of the a₁a₂ line that connects them=RED

Otherwise

2. If L_{T}<a_{z}<L_{T}+t(U_{T}−L_{T}) or U_{T}>a₂>U_{T}−t(U_{T}−L_{T}), then the color of the a₁a₂ line that connects them=YELLOW

Otherwise

3. If |a₂−a₁|>s(U_{T}−L_{T}), then the color of the a₁a₂ line that connects them=YELLOW

Otherwise

4. Then the color of the a₁a₂ line=GREEN, i.e. |a₂−a₁|<s(U_{T}−L_{T})

Where t=the percentage below U_{T} or above L_{T} which indicates a zone approaching one of the thresholds (warning zone). T is initially set to 25% (0.25), but it can be varied by the user to provide a greater or lesser warning zone size;

and where s=a percentage relating to the slope of a₁a₂ which could trigger a warning based on the “speed” at which a subsequent test is approaching a warning zone. S is initially set to 20% (0.2), but it can also be varied by the user to increase or decrease the slope of the test result as it approaches a warning zone.

The embodiments described above are merely exemplary illustrations of various implementations set forth for a clear understanding of the principles of the invention. Without departing from the scope of the invention, many modifications, variations, combinations, or equivalents may be substituted for elements of the above-described invention. Therefore, it is intended that the invention not be limited to the particular embodiments disclosed as the best mode contemplated for carrying out this invention, but that the invention will include all the embodiments falling within the scope of the appended claims.

TABLE 1
Shows the analytes displayed by the Health Data Application
that have a range. The ranges are derived from standard
blood and urine tests.

| | Min. Range | Max. Range | |
|---|---|---|---|
| Analyte | (L_{T}) | (U_{T}) | Unit |
| A/G Ratio | 1.1 | 2.5 | |
| Albumin, Serum | 3.5 | 4.5 | g/dL |
| Alkaline Phosphatase, S | 25 | 150 | IU/L |
| Alkaline Phosphate | | | |
| ALT (SGPT) | 0 | 55 | IU/L |
| Amylase | | | |
| AST (SGOT) | 0 | 40 | IU/L |
| B12 and Folate | | | |
| Basophils | 0 | 3 | % |
| Basophils (Absolute) | 0 | 0.2 | ×10E3/uL |
| Bilirubin, Total | 0 | 1.2 | mg/dL |
| BUN | 6 | 24 | mg/dL |
| BUN/Creatinine Ratio | 9 | 20 | |
| Calcium, Serum | 8.7 | 10.2 | mg/dL |
| Carbon Dioxide, Total | 20 | 32 | mmol/L |
| CEA | | | |
| Chloride, Serum | 97 | 108 | mmol/L |
| Cholesterol, Total | 100 | 199 | mg/dL |
| C-Reactive Protein | 0 | 3 | mg/L |
| Creatinine, Serum | 0.76 | 1.27 | mg/dL |
| Eosinophils | 0 | 7 | % |
| Eosinophils (Absolute) | 0 | 0.4 | ×10E3/uL |
| Estradiol | | | |
| Ferritin | | | |
| Globulin, Total | 1.5 | 4.5 | g/dL |
| Glom Filt Rate, Est | | >59 | mL/min/1.73 |
| Glucose, Serum | 65 | 99 | mg/dL |
| HDL Cholesterol | | >40 | mg/dL |
| Hematocrit | 36 | 50 | % |
| Hemoglobin | 12.5 | 17 | g/dL |
| Hemoglobin A1c | | <6 | % |
| Iron | | | |
| LDL Cholesterol Calc | | <130 | mg/dL |
| Lipase | | | |
| Lymphocytes | 14 | 46 | % |
| Lymphocytes (Absolute) | 0.7 | 4.5 | ×10E3/uL |
| Magnesium, Serum | 1.6 | 2.6 | mg/dL |
| MCH | 27 | 34 | pg |
| MCHC | 32 | 36 | g/dL |
| MCV | 80 | 98 | fL |
| MicroAlbumin, Random | | <30 | mcg/mg |
| Urine | | | |
| Monocytes | 4 | 13 | % |
| Monocytes (Absolute) | 0.1 | 1 | ×10E3/uL |
| Neutrophils | 40 | 74 | % |
| Neutrophils (Absolute) | 1.8 | 7.8 | ×10E3/uL |
| Phosphorous | 2.5 | 4.5 | mg/dL |
| Platelets | 140 | 415 | ×10E3/uL |
| Potassium, Serum | 3.5 | 5.2 | mmol/L |
| Protein, Total, Serum | 6 | 8.5 | g/dL |
| PSA, Serum | | <4.0 | ng/mL |
| RBC | 4.1 | 5.6 | ×10E6/uL |
| RDW | 11.7 | 15 | % |
| Sedimentation Rate- | 0 | 20 | mm/hr |
| Westergren | | | |
| Sodium, Serum | 135 | 145 | mmol/L |
| Thyroxine (T4) | 4.5 | 12 | ug/dL |
| Triglycerdes | 0 | 149 | mg/dL |
| Triiodothyronine (T3) | 71 | 180 | ng/dL |
| Trypsinogen | | | |
| TSH | 0.45 | 4.5 | Uiu/mL |
| Uric Acid, Serum | 4 | 8 | mg/dL |
| Urinalysis | | | |
| Vitamin D | 30 | 100 | ng/mL |
| VLDL Cholesterol Cal | 5 | 40 | mg/dL |
| WBC | 4 | 10.5 | ×10E3/uL |

What is claimed is:

1. A method for managing personal health data in a computing system, the method comprising:
maintaining a database containing personal health data on a computing device;
displaying personal health data on a user display;
computing trend lines from said personal health data;
displaying said trend lines on said user display.

2. The method according to claim 1, further including the steps of:
receiving by user input personal information including family and lifestyle data;
receiving by user input health data variables including procedural codes and ranges;
storing said personal information and said health data variables in said database.

3. The method according to claim 2, further including the steps of:
displaying user personal information on said user display;
displaying user family information on said user display;
receiving user input for dates of scheduled medical related events;
displaying reminders of said scheduled medical related events on said user display.

4. The method according to claim 1, further including the steps of:
transmitting said personal health data from said computing device to remote databases by way of network communications;
receiving said personal health data into said computing device from remote databases by way of network communications.

5. The method according to claim 4, further including the steps of:
displaying on said user display a list of facilities with accessible laboratory databases;
receiving user input to select one or more of said facilities with accessible laboratory databases;
receiving personal health data from said selected laboratory databases by network communications;
displaying said personal health data on said computing device's user display.

6. The method according to claim 1, further including the step of computing the user's body mass index and displaying it on said computing device's user display.

7. The method according to claim 1, further including the steps of:
receiving user input of test result threshold variables;
receiving user input of test result slope variables;
storing said variables in said computing system.

8. The method according to claim 7, further including the steps of:
displaying data for a plurality of analytes on said user display;
receiving analyte data by way of user input;
storing said analyte data in said database.

9. The method according to claim 8, further including the steps of:
displaying on said user display a plurality of pre-defined trending correlations;
receiving user input to select one of said pre-defined trending correlations;
applying trending algorithms to a plurality of sequential test results;
computing trend line colors using said trending algorithms;
displaying graphs of said trend line data on said user display.

10. A method for managing personal health data in a computing system, the method comprising:
maintaining, in a computing system, a database containing personal health data on a computing device;
receiving by user input personal health data;
communicating personal health data between a computing device and a remote system by way of network communications;
computing the user's body mass index;
receiving user input oft test result threshold variables and test result slope s variables;
receiving analyte data by way of user input;
receiving user input to select pre-defined trending correlations;
applying trending algorithms to a plurality of sequential test results;
computing trend line colors using said trending algorithms;
displaying graphs of trend line data on said user display;
displaying personal health data on a user display.

11. A personal health data management system, comprising:
a processor;
a storage device;
a user display; and
computer executable instructions operative on the processor for:
maintaining a database containing personal health data;
displaying personal health data on a user display;
computing trend lines from said personal health data;
displaying said trend lines on said user display.

12. The personal health data management system of claim 11, said computer executable instructions further comprising the steps of:
receiving by user input personal information including family and lifestyle data;
receiving by user input health data variables including procedural codes and ranges;
storing said personal information and said health data variables in said database.

13. The personal health data management system of claim 12, said computer executable instructions further comprising the steps of:
displaying user personal information on said user display;
displaying user family information on said user display;
receiving user input for dates of scheduled medical related events;
displaying reminders of said scheduled medical related events on said user display.

14. The personal health data management system of claim 11, further including the steps of transmitting said personal health data to and from said processor and remote databases by way of network communications.

15. The personal health data management system of claim 11, said computer executable instructions further comprising the steps of:
displaying on said user display a list of facilities with accessible laboratory databases;
receiving user input to select one or more of said facilities with accessible laboratory databases;
receiving by network communications personal health data from selected laboratory databases;
displaying said personal health data on said user display.

16. The personal health data management system of claim 11, said computer executable instructions further comprising the steps of:
computing the user's body mass index;
displaying said body mass index on said user display.

17. The personal health data management system of claim 11, said computer executable instructions further comprising the steps of:
receiving user input of test result threshold variables;
receiving user input of test result slope variables;
storing said variables in said database.

18. The personal health data management system of claim 17, said computer executable instructions further comprising the steps of:
displaying data for a plurality of analytes on said user display;
receiving analyte data by way of user input;
storing said analyte data in said database.

19. The personal health data management system of claim 18, said computer executable instructions further comprising the steps of:
displaying on said user display a plurality of pre-defined trending correlations;
receiving user input to select one of said pre-defined trending correlations;
applying trending algorithms to a plurality of sequential test results;
computing trend line colors using said trending algorithms;
displaying graphs of said trend line data on said user display.

20. A personal health data management system, comprising:
a processor;
a storage device;
a user display; and
computer executable instructions operative on the processor for:
maintaining a database containing personal health data on a computing device;
receiving by user input personal health data;
communicating personal health data between a computing device and a remote system by way of network communications;
computing the user's body mass index;
receiving user input of test result threshold variables and test result slope variables;
receiving analyte data by way of user input;
receiving user input to select pre-defined trending correlations;
applying trending algorithms to a plurality of sequential test results;
computing trend line colors using said trending algorithms;
displaying graphs of trend line data on said user display;
displaying personal health data on a user display.
